(19) United States
(12) Patent Application Publication
(10) Pub. No.: US 2026/0159007 A1
(43) Pub. Date: Jun. 11, 2026

(54) ACCESSORY ATTACHMENT DEVICE

(71) Applicant: Henry Munoz, JR., Cypress, TX (US)

(72) Inventor: Henry Munoz, JR., Cypress, TX (US)

(21) Appl. No.: 18/973,276

(22) Filed: Dec. 9, 2024

(51) Int. Cl. B60R 11/00

(52) U.S. Cl. CPC B60R 11/00; B60R 2011/0057; B60R 2011/0059

(57) ABSTRACT

An accessory attachment device and attachment method that includes a plurality of attachment mechanisms configured to attach the housing of the device to a golf cart. A telescopic rod may be placed in an opening on the housing of the accessory attachment device on the telescopic rod's proximal end and the telescopic rod may be configured to hold a wind reading device on its distal end. The housing of the accessory attachment device may further contain at least one carabiner or split ring on its underside configured to accommodate attachment of accessories. This accessory attachment device may be attached to and removed from a golf cart at any time.

### BACKGROUND

Wind direction and speed are critical factors that influence the distance, direction, and trajectory of golf shots. Golfers of all skill levels understand that these wind conditions directly impact their choice of club and shot selection.

Golfers employ various methods to gauge wind direction and speed, such as tossing grass blades into the air to observe their movement or interpreting the direction and intensity with which pin flags, tree branches, or leaves are blown. Golfers have also attempted artificial wind reading methods, such as affixing windsocks, flags, and ribbons to golf carts. However, many of these methods present challenges and limitations.

For instance, the Orkin patent, U.S. Pat. No. 4,719,798, discloses a wind reading ribbon that is attached to a golf cart via an adhesive material having a peel away sheet, which when removed, allows the wind direction finder to be attached to the canopy frame post of a golf cart. This product offers a system that is single use and intended to remain affixed to a single golf cart in perpetuity.

The Pearce patent, U.S. Pat. No. 5,540,181, discloses a wind-reading flag designed to attach to a golf cart through a complex mounting system that involves bolts, screws, and a cylindrical bore for fitting around a cylindrical section of the golf cart frame. This system is bulky, heavy, and requires significant effort to assemble. Additionally, it is limited to use exclusively with golf carts that have cylindrical frames.

Additionally, many existing products necessitate lengthy and confusing assembly, are bulky, or are less effective and versatile methods of providing a wind reading accessory.

Conventional wind-reading devices often fail to provide a quick, easy, and effective method for attachment to a base, such as a golf cart, while also delivering accurate and efficient measurements of wind direction and speed. Many require complex or time-consuming installation processes for attachment to a golf cart. Furthermore, these devices are often limited in functionality, being bulky, single-use, or non-reusable. Additionally, many products are designed exclusively for use on golf carts, making them ineffective for gauging wind in non-golf settings. As a result, these devices tend to be costly and have limited practical applications.

Accordingly, an improved method and system for reading wind direction and speed by using an accessory attachment device are desired.

### SUMMARY OF THE INVENTION

This summary is provided to introduce an accessory attachment device for a golf cart. The housing of the accessory attachment device is attached to a golf cart frame via a plurality of attachment mechanisms. The housing defines an opening configured for placement of a telescopic rod that is configured to hold a wind reading device. The housing further defines an orifice configured to accommodate attachment of other accessories via at least one carabiner or split ring. This summary is not intended for determining the scope of the claimed subject matter.

In one embodiment, the attachment mechanism includes at least one hook-and-loop strap.

In one embodiment, the attachment mechanism includes at least one non-slip rubber pad.

In one embodiment, the attachment mechanism includes at least one magnet.

In one embodiment of the present disclosure provides an accessory attachment device for attachment to a base, such as a golf cart, including a housing of the device with a plurality of attachment mechanisms. The housing of the device may have magnets configured as an attachment mechanism to metal surfaces. The housing of the device may include non-slip rubber pads to prevent slippage of the housing. The housing of the device may include hook-and-loop straps as an attachment mechanism against any surface.

Another embodiment of the present disclosure provides a method for accommodating attachment of accessories. The disclosed method may include: the orifice integrated into the underside of the housing of the device configured for attachment of at least one carabiner or split ring, carabiners or split rings configured to accommodate attachment of accessories, such as a portable speaker or a towel. By attaching a wind reading device to the telescopic rod described herein to the accessory attachment device described herein, a system is formed for gauging wind speed and direction while playing golf.

Other illustrative variations within the scope of the present invention will become apparent from the detailed description provided hereinafter. The detailed description and enumerated variations, while disclosing optional variations, are intended for purposes of illustration only and are not intended to limit the scope of the present invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a side view of an accessory attachment device secured to a golf cart, according to the disclosed embodiments;

FIG. 2 illustrates an enhanced view of the accessory attachment device as seen in FIG. 1, according to the disclosed embodiments.

FIG. 3 illustrates a rear view of the housing of the device attached to a golf cart, according to the disclosed embodiments.

FIG. 4 illustrates an angled view of the housing of the device portion of the accessory attachment device without straps, showing the orifice on the underside of the housing of the device, according to the disclosed embodiments.

FIG. 5 illustrates a different angled view of the housing of the device portion of the accessory attachment device without straps, showing the top side of the housing of the device, according to the disclosed embodiments.

FIG. 6 illustrates a different angled view of the housing of the device portion of the accessory attachment device without straps, showing the golf cart facing side of the housing of the device, according to the disclosed embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular systems and methods. Accordingly, the method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to an accessory attachment device as an assembly comprising a combination of: a housing of the device; a telescopic rod; a method for reading wind direction and speed; and a method to accommodate attachment of additional accessories to the accessory attachment device, to: provide a versatile and compact device to, for example, provide a means to read wind direction and speed in any context, for example, during a round of golf.

An accessory attachment device is an assembly that includes a housing of the device, a telescopic rod, a wind reading device, and an orifice. The telescopic rod is operatively connected to the backside of the housing of the device. A wind reading device, such as a windsock, is operatively connected to the distal end of the telescopic rod.

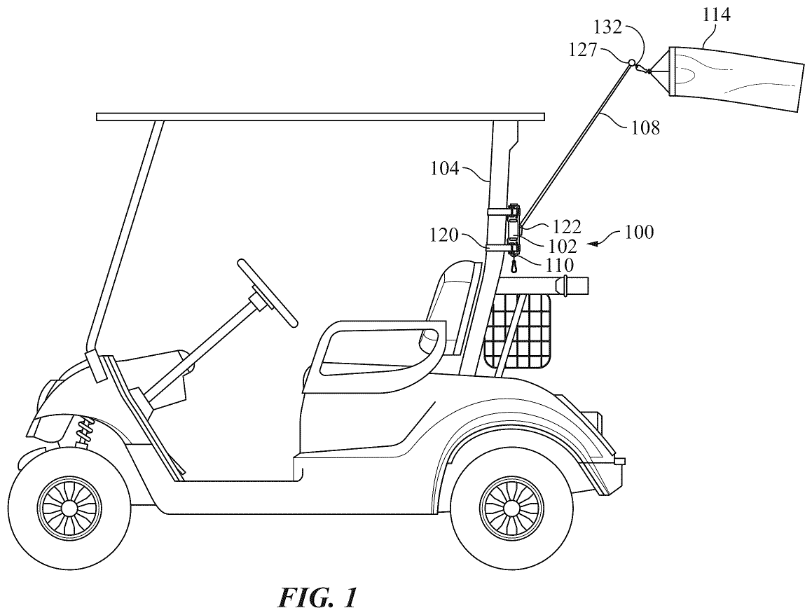

FIG. 1 illustrates a profile view of an accessory attachment device 100 attached to a golf cart frame 104, according to the disclosed embodiments.

Referring to FIG. 1, the accessory attachment device 100 implemented as a removable wind reading 114 and accessory attachment device 100 to be connected to, for example, a golf cart frame 104. The accessory attachment device 100 provides functionality for gauging wind speed and direction by attaching a wind reading device 114 via a second carabiner 132 to a ring 127 located at a distal end of the telescopic rod 108. In one embodiment, the telescopic rod 108 is connected to the holder 122 on the backside of the housing 102. In one embodiment, the telescopic rod 108 may be extended or collapsed within the holder 122 for facilitating the desired positioning of the wind reading device 114 away from a golf cart for effective reading of wind direction and speed during a round of golf. In one embodiment, the housing 102 may be attached to a golf cart frame 104 via a plurality of hook-and-loop straps 120. In one embodiment, a plurality of accessories, such as a portable speaker or golf towel, may be attached to the orifice 110 via at least one carabiner 112 or at least one split ring 103 on the underside of the housing 102.

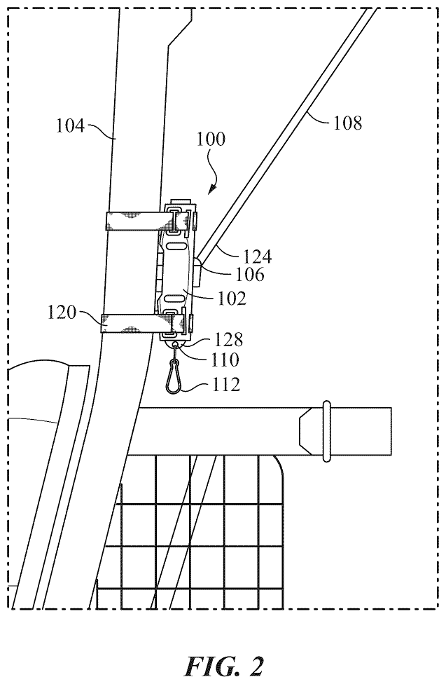

FIG. 2 the accessory attachment device 100 as discussed in FIG. 1, according to the disclosed embodiments.

Referring to FIG. 2, the accessory attachment device 100 implemented as a removable accessory attachment device 100 to be connected to, for example, a golf cart frame 104. In one embodiment, the housing 102 may be attached to a golf cart frame 104 via a plurality of hook-and-loop straps 120. In one embodiment, the accessory attachment device 100 provides a telescopic rod 108, connected to the housing 102 on the proximal end 124 of the telescopic rod 108, allowing for extension of the telescopic rod 108 away from the golf cart frame 104 or retraction into the opening 106 of the housing 102. In one embodiment, at least one carabiner 112, configured to accommodate attachment of a plurality of accessories, such as a portable speaker or golf towel, may be attached to at least one carabiner 112 or at least one split ring 103 on the accessory attachment point 128 on the underside of the housing 102.

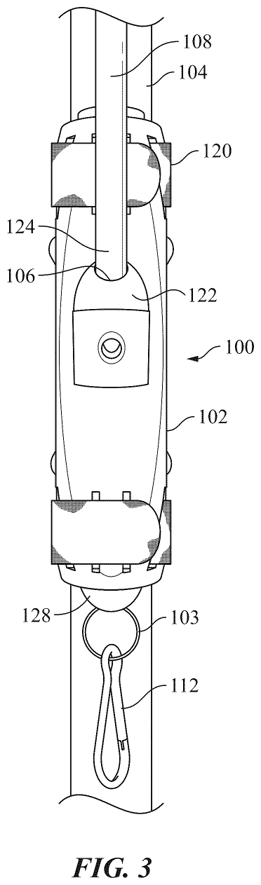

FIG. 3 illustrates a rear view of the accessory attachment device 100 as attached to a golf cart frame 104, according to the disclosed embodiments.

Referring to FIG. 3, the accessory attachment device 100 is connected to a golf cart frame 104. In one embodiment, the housing 102 may be attached to a golf cart frame 104 via a plurality of hook-and-loop straps 120. In one embodiment, the accessory attachment device 100 provides a telescopic rod 108 placed in the housing 102 at the proximal end 124 of the telescopic rod 108 for extension away from the golf cart frame 104 and retraction into the opening 106 of the holder 122 on the backside of the housing 102. In one embodiment, at least one split ring 103 or at least one carabiner 112, configured to hold a plurality of accessories, such as a portable speaker or golf towel. At least one split ring 103 or at least one carabiner 112 may be attached to the accessory attachment point 128 on the underside of the housing 102.

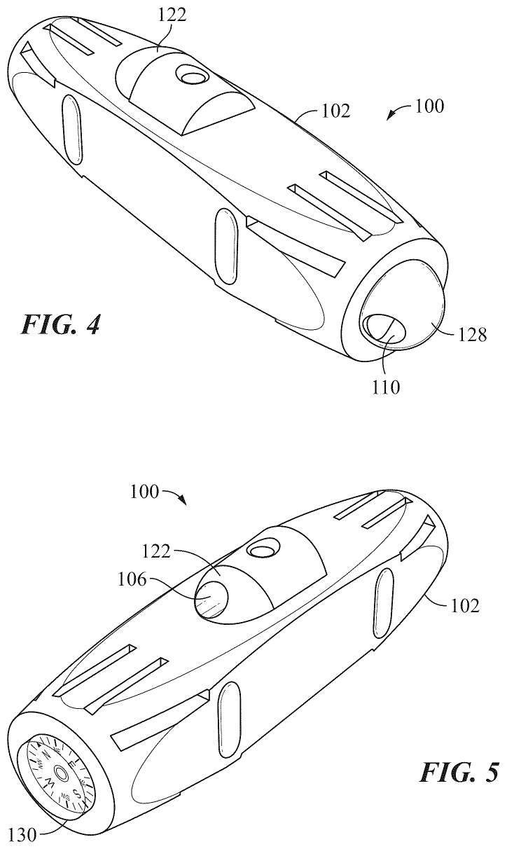

FIG. 4 illustrates an angled view of the housing 102 of the accessory attachment device 100, according to the disclosed embodiments.

Referring to FIG. 4, in one embodiment, the housing 102 may comprise a holder 122 configured for placement of the proximal end 124 of telescopic rod 108 (not shown), or other attachment device. In one embodiment, the housing 102 may include an accessory attachment point 128, comprising the orifice 110 for attachment of accessories to the accessory attachment device 100 via at least one split ring 103 or carabiner 112, as depicted in FIG. 3.

FIG. 5 illustrates a different angled view of the housing 102 of the accessory attachment device 100, according to the disclosed embodiments.

Referring to FIG. 5, in one embodiment, the housing 102 may comprise a holder 122 comprising an opening 106 configured for placement of the proximal end 124 of telescopic rod 108, as depicted in FIG. 1-3, or other attachment device. In one embodiment, the housing 102 of the accessory attachment device 100 may comprise at least one compass 130 on the top of the housing 102 for reading direction.

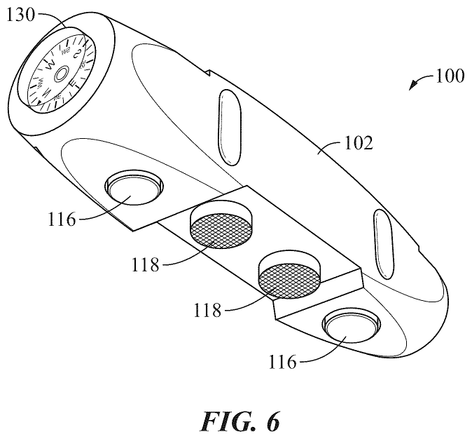

FIG. 6 illustrates a different angled view of the housing 102 of the accessory attachment device 100, according to the disclosed embodiments.

Referring to FIG. 6, in one embodiment, the housing 102 of the accessory attachment device 100 may comprise at least one magnet 116 as an attachment mechanism of the housing 102 to a surface. In one embodiment, the housing 102 of the accessory attachment device 100 may comprise a plurality of non-slip rubber pads 118 to prevent slippage of the housing 102 against a surface. In one embodiment, the housing 102 of the accessory attachment device 100 may comprise at least one compass 130 on the top of the housing 102 for reading direction.

The accessory attachment device described herein addresses the unique challenges faced by golfers when considering shot selection by focusing on accuracy in the gauging of wind speed and direction. Current devices and methods for gauging wind speed and direction can be cumbersome and imprecise. The accessory attachment device and method for application described herein allow for use with and reuse with a plurality of surfaces and is reliable with regards to accurate gauging of wind direction and speed.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. An accessory attachment device for a golf cart frame comprising:
a housing configured to be attached to the golf cart frame by an attachment mechanism;
a holder integrated into the housing which defines an opening for placement of a telescopic rod configured to fit into the opening; and
an orifice configured to hold at least one carabiner configured to hold accessories.

2. The accessory attachment device of claim 1, wherein the attachment mechanism comprises at least one strap.

3. The accessory attachment device of claim 2, wherein the plurality of straps comprises portions attachable by hook-and-loop.

4. The accessory attachment device of claim 1, wherein the attachment mechanism comprises at least one magnet.

5. The accessory attachment device of claim 1, wherein the attachment mechanism comprising at least one non-slip rubber pad.

6. The accessory attachment device of claim 1, wherein the housing of the accessory attachment device defines the opening located on a side of the housing configured for placement of the proximal end of the telescopic rod.

7. The accessory attachment device of claim 6, wherein the telescopic rod comprises a ring located at a distal end of the telescopic rod configured for attachment of a wind reading device, including, but not limited to, any of:
a device for gauging wind direction;
a windsock;
a banner; and
a flag.

8. The accessory attachment device of claim 1, wherein the housing comprises the orifice located on an underside of the housing configured to accommodate attachment of accessories via at least one carabiner.

9. The accessory attachment device of claim 1, wherein the housing comprises the orifice configured to hold at least one split ring.

10. The accessory attachment device of claim 8, wherein the housing comprises the orifice located on the housing configured to accommodate attachment of accessories via the at least one split ring.

11. A method for application of an accessory attachment device for a golf cart:
attaching the accessory attachment device to a golf cart frame, wherein the accessory attachment device comprises: a housing configured to be attached to the golf cart frame by an attachment mechanism;
a holder integrated into the housing which defines the opening for placement of a telescopic rod configured to fit into the opening; and
the orifice configured to hold at least one carabiner configured to hold accessories.

12. The method for application of the accessory attachment device of claim 11, wherein the attachment mechanism comprises at least one strap configured to secure the housing around the golf cart frame.

13. The method for application of the accessory attachment device of claim 11, wherein the accessory attachment device comprises at least one magnet configured to attach the housing to the golf cart frame.

14. The method for application of the accessory attachment device of claim 11, wherein the accessory attachment device comprises at least one non-slip rubber pad configured to be placed between the housing and the golf cart frame.

15. The method for application of the accessory attachment device of claim 11, wherein the housing of the accessory attachment device further defines the opening located on a side of the housing configured for placement of the proximal end of the telescopic rod.

16. The method of claim 11, further comprising the step of: connecting a wind reading device to the telescopic rod using a second carabiner.

17. The method of claim 16, wherein the wind reading device is any of:
a device for gauging wind direction;
a windsock;
a banner; and
a flag.
